(19) United States
(12) Patent Application Publication
(10) Pub. No.: US 2002/0109485 A1
(43) Pub. Date: Aug. 15, 2002

(54) Battery charging device

(76) Inventor: Ten-Der Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/118,013

(22) Filed: Apr. 9, 2002

Related U.S. Application Data
(63) Continuation-in-part of application No. 09/732,303, filed on Dec. 8, 2000.

(51) Int. Cl. H02J 7/04; H02J 7/16

(52) U.S. Cl. 320/157

(57) ABSTRACT

A battery charging device both for charging a battery and for actuating a car engine includes a switch power supply circuit, a first, second, and third control circuit, and two control switches. While actuating the car engine, the battery charging device further employs a transient large current stage connected to the car engine. Users are capable of manually selecting the amount of the charging current for the battery and manually selecting different types of batteries to be charged. The battery is charged in the conductive time periods, and the voltage of the battery will be detected at the end of every conductive time period for determining entering next conductive time period or not. The battery charging device charges the battery with a constant current or with a smaller current under a constant voltage until the battery is fully charged.

### CROSS-REFERENCE TO RELATED APPLICATIONS

This Application is a Continuation-In-Part of application Ser. No. 09/732,303, filed Dec. 8, 2000, and entitled Digital Battery Charging Device.

### BACKGROUND OF THE INVENTION

1. Field of the Invention

The present invention relates to a battery charging device, and more particularly, to a battery charging device not only can charge a variety of batteries under different constant currents or smaller currents with constant voltages, without any damage to these batteries, and actuate a car engine by switching its operation mode.

2. Description of the Prior Art

Referring to FIG. 1 of a block diagram of a prior art battery charging device, such a battery charging device fed with an A.C. input and supplying the A.C. input to a transformer 60 through a switch. The current outputted from the transformer 60 is further rectified by a rectifying diode 65 for charging a battery 70.

A voltage detecting circuit is coupled between the output of the rectifying circuit 65 and the switch SW. The voltage detecting circuit detects the output voltage of the charging device and affects the switch SW in accordance therewith, i.e., either to close the switch SW to supply the A.C. power to the transformer 60, or to open the switch SW in order to disconnect the transformer from the A.C. power source, as shown in FIG. 1.

Disadvantageously, the prior art charging device fails to provide a comprehensive control during the charging process, thus highly subject to battery parameters, such as state of charging and aging of the battery. Besides, the charging device shown in FIG. 1 is not fully protected from “short” if the battery is with inverse contact polarity with the charging device.

Specifically, since the charging for a battery is performed with a constant voltage, the aforementioned battery parameters play very important roles in affecting the final result of the charging process. Further, if the charging period lasts too long, consequent overheat may result damages to the battery. Besides, the A.C. current may uncontrollably vary due to changes of battery parameters and the fluctuation in A.C. power source, if no filtering function is incorporated in charging device, like the embodiment of prior art, excessive ripples may occur in the circuit, thus undermining the entire performance of charging process. Further, if the battery is short-circuited, the charging device will consume a large amount of current, thus dangerous to both the charging device and battery. The prior art charging device is without the function of cutting the charging current instantly while the inverse polarity contact inadvertently occurs, even a double metal switch is employed in the charging device. Moreover, the prior art charging device only focuses on battery charging, and, in generally, it is impossible to actuate a car engine based on the prior art charging function. Even this defect may be overcome by adding a large transformer into the charging device, however, it is not practical in the cost-wise.

### SUMMARY OF THE INVENTION

Accordingly, the primary object of the present invention is to provide a battery charging device with functions of preventing battery overheat because the charging operation is only executed in the conductive time periods and stopping charging as the battery has reaches to the predetermining voltage level. Furthermore, at the end of conductive time periods, the battery charging device will detect the current voltage value for the battery for the purpose of determining whether entering next conductive time period or not. If the voltage value of the battery has not reached to the preset value yet at the end of one conductive time period, after one intermittent non-conductive time period, the battery will enter another conductive time period.

Another object of the present invention is to provide a battery charging device employs a stable charging process and free of current ripples in the charging current which may occur during rectifying the input A.C. power.

It is still another object of the present invention to provide a battery charging device including an inverse polarity protection circuit for ceasing the charging current once the inverse polarity occurs between the battery and charging device. The further object of the present invention are with manually selecting the amount of charging current and different types of batteries, and assisting to actuate car engines.

The various objects and advantages of the present invention will be more readily understood from the following detailed description when read in conjunction with appended drawings.

### BRIEF DESCRIPTION OF THE DRAWINGS

FIG. 1 is a function block diagram of a prior art charging device.

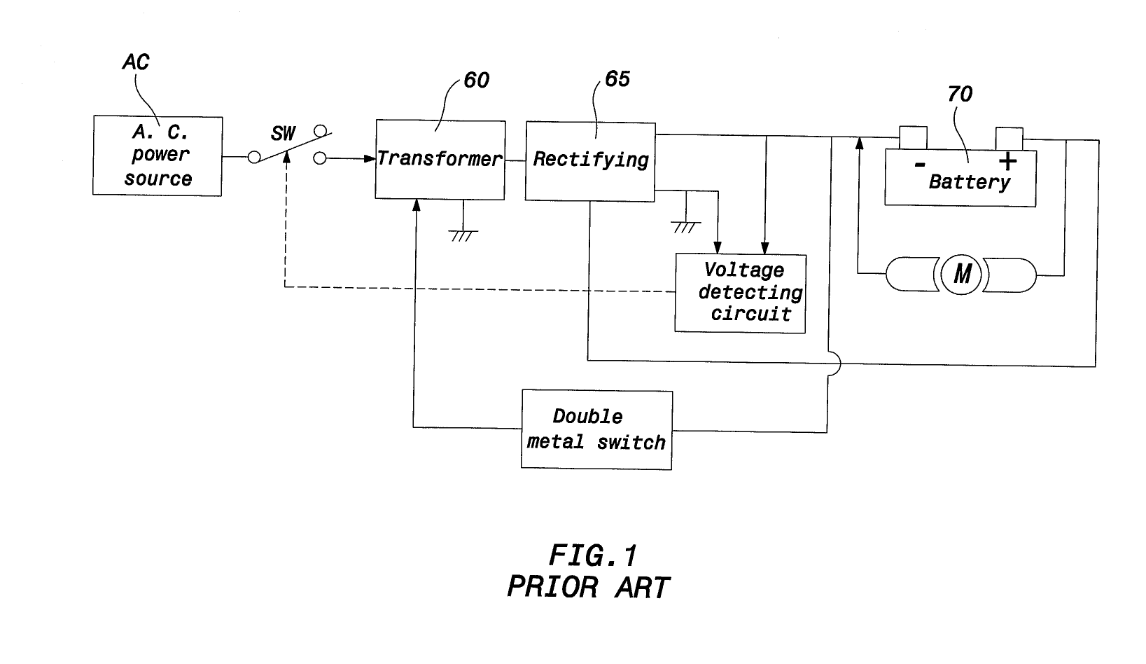

FIG. 2 is a circuit block diagram according to the present invention charging device.

FIG. 3 is a circuit block diagram of another embodiment of the present invention.

### DETAILED DESCRIPTION OF THE PREFERRED EMBODIMENTS

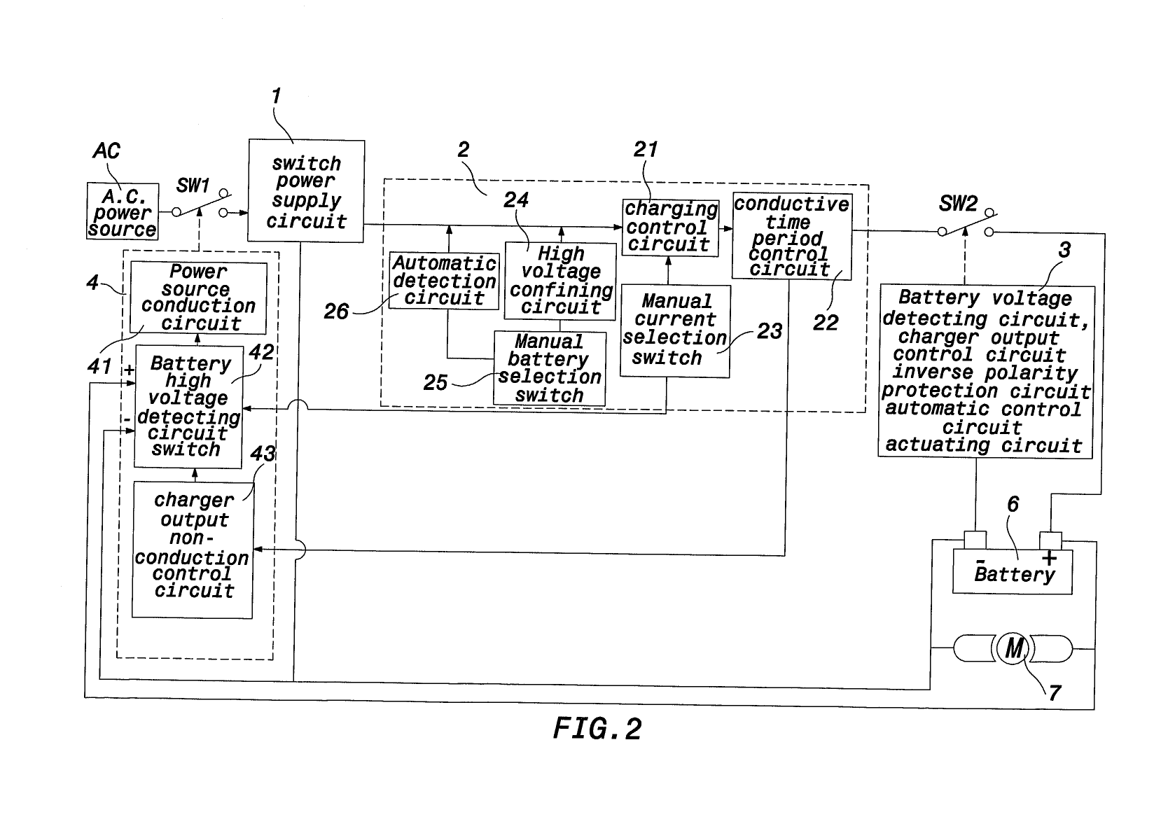

Referring to FIG. 2, a battery charging device of the present invention includes a switch power supply circuit 1, a first control circuit 2, a second control circuit 3, a third control circuit 4, and two control switches SW1 and SW2 for charging a battery 6 which supplies the power to an engine 7.

The switch power supply circuit 1 is connected to an A.C. power source through the first control switch SW1 to convert the input A.C. power into D.C. power which powers all elements of the battery charging device.

The first control circuit 2 includes a charging control circuit 21 having an input connected to the switch power supply circuit 1 and an output connected to a conductive time period control circuit 22. The output of output conductive time period control circuit 22 is connected to the battery through the second control switch SW2. The positive and negative terminals of the battery 6 are connected to the engine 7. The charging control circuit 21 is connected to a manual current selection switch 23 used to manually select the amount of the current flow, such as 2 amperes, 5 amperes, or 10 amperes.

The first control circuit 2 defines a plurality of conductive and non-conductive intermittent time periods. The manual current selection switch 23 sets the current of the charging control circuit 21, so that the battery 6 is charged by a constant current during the conductive time periods. Moreover, the battery 6 is charged under a constant voltage when the battery 6 has reached a preset value, thereby decreasing the charging current to a level of cutting off power of the battery charging device. By this way, an optimum charging efficiency is achieved, and the battery 6 is protected from overcharging, thus, the lifetime of the battery 6 increases.

The conductive time period control circuit 22 is to control the length of time span of conductive and non-conductive time periods. During the conductive time periods, the battery 6 is charged under the constant current or voltage operation mode. In the end of every conductive time period, the voltage of the battery 6 will be detected, for the purpose of entering another conductive time period or not. In other words, when the voltage of the battery 6 at the full-charge level, the A.C. power source is cut off automatically, and, if not reached to the full-charge level yet, the battery charging process resumes during the next conductive time period.

In order to avoid overcharging of the battery 6, as it is charged under a constant current, a high voltage confining circuit 24 outputs a high voltage for confining the charging current. The input of the high voltage confining circuit 24 is connected to a manual battery selection switch, which serves to manually select a kind of battery from various available types of batteries, like the water, dry battery, or etc.

An automatic detection circuit 26 is connected between the input of the charging control circuit 21 and the manual battery selection switch 25. The automatic detection circuit 26 serves to set the target voltage of the battery 6 according to the setting of the manual battery selection switch 25. To be more specifically, once the type of the battery 6 is selected, the automatic detection circuit 26 receives the “data” from the manual battery selection switch 25 to prevent charging one type of the battery to a voltage of different type of battery.

The full-charge voltage level of the battery 6 and its maximum output of the battery charging device are configured based on the charging current so as to protect the battery 6 from being overcharged.

The second control circuit 3 is connected to a second control switch SW2 and has functions of detecting the voltage of the battery 6, controlling the output of the charging device, and the inverse polarity protection. The second control circuit 3 is connected to the positive and negative terminals of the battery 6. If the connection of terminals of the battery 6 is incorrect, the second control switch SW2 will not turn on for preventing the battery 6 from being destroyed. Furthermore, if the voltage of the battery 6 is lower than 5 volts, representing the battery 6 is subject to some unknown problems, thereby the battery charging device will not charge the battery 6 for protecting the battery 6 and the battery charging device. And, if the battery charging device does not connect with the battery 6, it will not operate for the same safety concern as well.

The third control circuit 4 is connected to the first control switch SW1, first control circuit 2 and battery 6. The third control circuit 4 includes a power source conduction circuit 41, a battery high voltage detecting circuit switch 42, and a charger non-conduction control circuit 43. The charger non-conduction control circuit 43 has an input coupled to the conductive time period control circuit 22 of the first control circuit 2, and an output connected to the battery high voltage detecting circuit 42. The battery high voltage detecting circuit 42 includes inputs coupled to the positive and negative terminals of the battery 6, the charger output non-conduction control circuit 43, and the manual current selection switch 23. The battery high voltage detecting circuit switch 42 further includes an output connected to the power source conduction circuit 41. The power source conduction circuit 41 has an output coupled to the first control switch SW1.

The third control circuit 4 detects a second voltage of the battery 6 in the end of one conductive time period, for the purpose of determining entering next conductive time period or not. If the second voltage of the battery 6 reaches to the predetermining value, which is indicative of an accomplished charging state of the battery 6, in the end of one conductive time period, the A.C. power source will not be connected to the charging device because the power source conduction circuit 41 turns the first control switch coupled to the A.C. power source off. However, if the voltage of the battery 6, which is detected by the battery high voltage detecting circuit 41, has not reached to the preset value yet, the battery 6 will enter next conductive time period.

Besides, the second control circuit 3 further includes an automatic control circuit and an actuating circuit. When a user knows that the battery 6 is over-discharged, so that the voltage of the battery 6 is less than 5 volts, insufficient to actuate the battery charging device, then the actuating circuit will actuate the automatic control circuit to charge the battery 6 when connected with the battery charging device. The actuating circuit and automatic control circuit are configured as a switch, thus even if the battery is with a voltage not sufficient to enable the battery charging device to operate, by pressing the switch, the battery can be charged as well as normal condition.

The second control circuit 3 coupled between the second control switch SW2 and the battery 6 is also for detecting a first voltage of the battery 6. If the detected first voltage of the batter 6 is indicative of inverse polarity coupling of the battery 6 to the battery charging device, the second control switch SW2 will be turned off. The third control circuit 4 is capable of accurately detecting the voltage of the battery 6, thereby preventing the battery 6 from being overcharged. Moreover, the conductive and non-conductive time periods are intermittent, thus, the battery 6 will not enter an “overheat” state due to continuous battery charging.

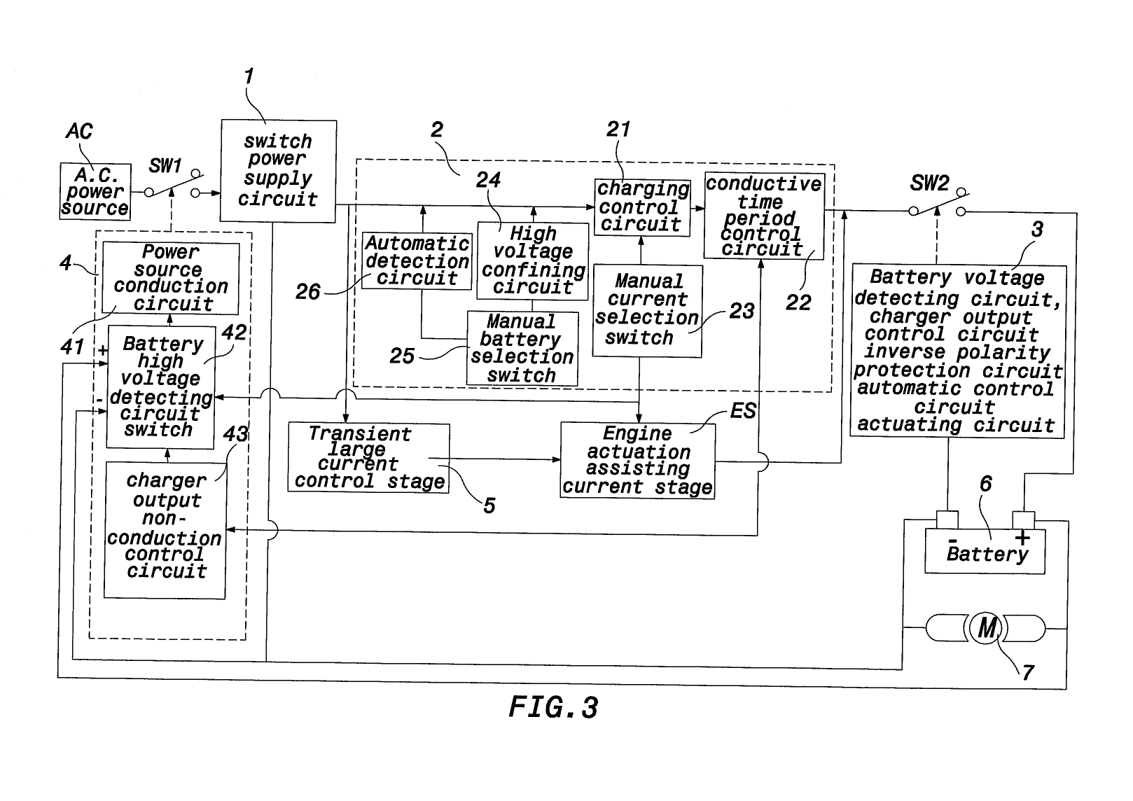

Please refer to FIG. 3 of a schematic diagram of another embodiment of the present invention. Comparing with FIG. 2, the present invention further includes a transient large current control stage 5. The manual current selection switch 23 has additional selection, namely engine actuating assisting current stage “ES”, besides 2, 5, or 10 amperes. While the manual current selection switch 23 has been switched to the “ES” state, the battery charging device at this point is used for starting a car engine. At this moment, the first and third control circuit 2 and 4 are disconnected with the car engine, which connects to the A.C. power source and the first switch SW1 directly through the transient large current control stage 5. Besides, the amount of the supplied current can be selected from 20, 50, or 70 amperes.

Since there are variety kinds of different car engines, the present invention should be well equipped for supplying different actuating currents. If the actuating current supplied by the present invention is less than the required actuating current of the car engine, the battery 6 will be charged for a period of time, about three to five minutes, before being capable of actuating the car engine successfully.

In comparison with prior arts, the present invention can not only charge a battery with a constant current or a smaller current under a constant voltage, but also assist actuating a car engine while switching the manual current selection switch into the engine actuating assisting current stage. Moreover, users also can manually select the type of battery they want to charge, and, once a specific type of battery is selected, corresponding “data” will be outputted from the manual battery selection switch and received by the automatic detection circuit for the purpose of preventing the battery from being charged to a non-corresponding voltage. Furthermore, the present invention includes functions of inverse polarity protection and actuating the battery charging device itself to charge the battery by pressing a switch. The present invention defines a plurality of conductive and non-conductive intermittent time periods, wherein charging the battery during the conductive time periods, and detecting the voltage of the battery during the non-conductive time periods to recognize whether the voltage of the battery has reached to a predetermining value. The setting of intermittent conductive and non-conductive time periods are for the safety concern of the battery charging device.

Although the present invention has been described with reference to the preferred embodiments, it will be understood that the invention is not limited to the details described therein. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A battery charging device comprising:
(a) a switch power supply coupled to an A.C. power source for converting an A.C. power supplied from said A.C. power source into a D.C. power;
(b) a first control switch coupled to between said A.C. power source and an input of said switch power supply circuit;
(c) a second control switch;
(d) a first control circuit coupled by an input thereof to an output of said switch power supply circuit to receive said D.C. power therefrom, said first control circuit being further coupled by an output thereof to a battery to be charged through said second control switch, said first control circuit defining a plurality of conductive and non-conductive intermittent time periods, wherein a charging circuit is actuated from said output of said first control circuit to said battery during at least the first of said conductive time periods, and wherein, during said non-conductive time periods, the supply of the charging current to said battery is ceased;
(e) a second control circuit coupled between said second control switch and said battery, said second control circuit detecting a first voltage of the battery and turning said second control switch off after said detected first voltage of the battery is indicative of inverse polarity coupling of the battery to said battery charging device; and
(f) a third control circuit coupled by a first input thereof to said first control circuit, by a second input thereof to said battery, and by an output thereof to said first control switch, said third control circuit detecting a second voltage of the battery at the end of said at least first conductive time period and turning said first control switch off after said second voltage of the battery has reached a predetermining voltage value indicative of accomplished charging state of the battery.

2. The battery charging device of claim 1 wherein said first control circuit further comprises a charging control circuit coupled by an input thereof to said switch power supply circuit, a conductive time period control circuit coupled between an output of said charging control circuit and said second control switch, and a manual current selection switch coupled to said charging control circuit.

3. The battery charging device of claim 2 further comprising a transient large current control stage coupled to said output of said switch power supply circuit, said manual current selection switch further switching said charging control circuit into an engine actuating assisting current stage mode of operation, said transient large current control stage being actuated after said manual current selection switch switches said charging control circuit into said engine actuation assisting current stage.

4. The battery charging device of claim 2 wherein said charging control circuit is connected to said manual current selection switch for selecting and adjusting an amount of charging current outputted from said battery charging device.

5. The battery charging device of claim 4 wherein said manual current selection switch sets said amount of charging current at levels of 2, 5, and 10 amperes.

6. The battery charging device of claim 2 further comprising a high voltage confining circuit coupled to an input of said charging control circuit for preventing an excessive current being supplied to said battery in said at least first conductive time period, and a manual battery switch coupled to an input of said high voltage confining circuit.

7. The battery charging device of claim 6 further comprising an automatic detection circuit connected between said input of said charging control circuit and said manual battery selection switch for defining a target voltage of said battery.

8. The battery charging device of claim 1 wherein said second control circuit includes a battery voltage detection circuit, a charger output control circuit, an inverse polarity protection circuit, an automatic control circuit, and an actuating switch.

9. The battery charging device of claim 1 wherein said third control circuit further includes a charger output non-conduction control circuit coupled by an input thereof to said conductive time period control circuit, a battery high voltage detecting circuit switch coupled by an input thereof to said charger output non-conduction control circuit, said battery high voltage detecting circuit being connected to said manual current selection switch, an output of said battery high voltage detecting circuit being connected to a power source conduction circuit, and an output of said power source conduction circuit being connected to said first control circuit.
